(19) United States
(12) Patent Application Publication
(10) Pub. No.: US 2010/0072193 A1
(43) Pub. Date: Mar. 25, 2010

(54) METHOD AND APPARATUS FOR THE HEAT TREATMENT OF WELDS

(76) Inventors: Lutz Kuemmel, Juechen (DE); Holger Behrens, Erkrath (DE); Christian Lengsdorf, Remscheid (DE); Robert Juergens, Remscheid (DE)

Correspondence Address: K.F. ROSS P.C., 5683 RIVERDALE AVENUE, SUITE 203 BOX 900, BRONX, NY, 10471-0900, US

(21) Appl. No.: 12/515,555

(22) PCT Filed: Nov. 21, 2007
(86) PCT No.: PCT/EP2007/010074

§ 371 Date: May 20, 2009

(30) Foreign Application Priority Data
Nov. 22, 2006 (DE) 10 2006 055 402.7
May 26, 2007 (DE) 10 2007 024 654.6
Nov. 15, 2007 (DE) 10/2007 054 876.3

(51) Int. Cl. H05B 6/06; B23K 26/42

(52) U.S. Cl. 219/661; 219/121.64

(57) ABSTRACT

To improve and further develop the heat treatment of the weld and the joining weld regions (6, 7) before and behind the actual welding by means of a laser, which is carried out during welding of steel sheets (2) to minimize the risk of crack formation or alteration of the microstructure in the region of the weld, it is proposed according to the invention that the heating of the region of the weld (6, 7) be carried out by means of a multiply stepped line inductor (4, 5) which can be set in a defined way and has zones of different power densities and is configured with a multiple division of its conductor loop lengths and/or with different plating of the conductor loops and/or with a plurality of spacing steps from the steel strip (2). Here, a steeper temperature rise occurs in the first heating stage than in the subsequent heating stage.

The invention relates to a method and an apparatus for the inductive heat treatment of weld seams in a welding machine with a laser welding head for connecting steel strips, a heating process of the weld seam and the adjacent weld seam areas upstream of and downstream of the actual welding being carried out by line inductors.

In the welding and in particular in the laser welding of metal sheets, a very large amount of energy is transmitted to a very narrow area of the joint zone in a concentrated manner. Since the metal sheet areas adjoining this greatly heated area are at ambient temperature, very rapid cooling occurs following the welding due to the high temperature gradient. Structural changes result that can substantially impair the mechanical properties in this area. Attempts are therefore made to influence the cooling after the welding operation through a targeted heat treatment of this affected weld seam area to both sides of the actual weld. The objective of the preheating is thereby to avoid cracks forming directly following the welding operation and the increase of the energy content of the seam area to reduce the cooling rate. The postheating occurring after the welding then serves to further reduce the cooling rate.

The heat treatment of the weld seam area can thereby be carried out by thermal heating, for example, by gas torches or plasma torches or by inductive heating. The heat treatment of the weld seam is usually carried out through the arrangement on one side of the gas torches or the inductors above or below the strip. This results in a process-related nonuniform temperature distribution and as a result a nonuniform heat treatment over the depth of the weld. With short heating times and high specific heating capacities, this asymmetry is further intensified.

Various methods and apparatuses are known for the heat treatment necessary for the reasons given above. For example, a process for laser welding with pre and/or postheating in the area of the weld seam is known from DE 10 2004 001 166 [US 20040188394], which is carried out with the laser beam of the laser welding head, the laser being guided with substantially the same output as required for welding and the same focusing, but an increased rate of advance and in certain cases several times over the seam area to be treated. An alternative to this method entails lies in that the laser beam is defocussed and in some cases also moved more slowly over the seam area to be treated.

EP 1 285 719 [U.S. Pat. No. 6,843,866] describes laser build-up welding on a rotating shaft, an inductor in the shape of a circle segment being used to preheat in steps and having inductor segments placed against the shaft locally upstream of the laser beam machining head. Two preheating cycles are carried out with two different inductors fixed with respect to one another and relative to the laser beam incidence point, the heat flow density of the first inductor being smaller and the heat action time and the effective area of the inductor being greater than the corresponding values of the second inductor. The increase of temperature accordingly is carried out in the first preheating cycle more gradually than in the second preheating cycle. The two inductors can be operated with different frequencies, but they can also be physically combined in one inductor, different inductive field concentrations being achieved by magnetic field intensification elements, a different inductor cross section or a narrower coil space. In the case of particularly fracture-sensitive materials, an inductive postheating cycle can also be added, the inductor used here being combined with the two inductors of the preheating cycles to form a common inductor.

In DE 101 52 685 an apparatus is proposed with which the weld seam and the heat-affected zones on both sides of the weld seam of a welded workpiece are locally inductively heat treated with one or more line inductors arranged one downstream of the other along the weld seam rigidly in the case of off-line operation or in a displaceable manner in the case of on-line operation. Shields are provided for the line inductors within the range of action of the line inductors such that they shield a part of the workpiece area impinged by the line inductors during operation from the alternating magnetic field generated by the line inductors.

Based on this described prior art, the object of the invention is to further develop a method of and an apparatus for the heat treatment of weld seams of the type mentioned above such that the risk of crack formation or structural change in the area of the weld seam during the welding of metal sheets is largely minimized.

This object is attained with the characterizing features of claim 1 in terms of method in that the heating of the weld seam area is carried out by a multipart line inductor whose parts can define zones of different power densities, the inductor having a multiple division of its conductor loop lengths and/or with a different plating of the conductor loops and/or with a plurality of spacing steps from the steel strip.

An apparatus for carrying out this method is characterized by the features of claim 9.

The multiple-stage heating is carried out according to the invention by a division of the entire heating power density to be applied for the heating to the individual heating stages, a steeper temperature increase taking place in the first heating stage than in the following heating stage. Thus, for example, the power distribution between the first and the second heating stage is carried out in a ratio of 3:1 in the case of two-stage heating. The result of this type of power distribution is a slower increase in temperature in the second heating stage compared to the first heating stage. Not only is a smaller temperature gradient between the upper surface of the strip and the lower surface of the strip with respect to a single-stage heating stage achieved this way, but the risk of overheating the structure when approaching the desired end temperature is also minimized. Advantageously, a dwell time with a specially adjusted temperature determined by temperature measurement with subsequent cooling of the previously heated weld seam area can also be set between individual heating stages in the case of the multi-stage heating, which is then followed by a reheating. To generate these equalization zones between individual heating zones, for example, individual conductor loops can be separated.

The line inductors for the preheating and postheating according to the invention are controllable individually or together, without rigid coupling laser welding head and line inductors, for example, so they move on separate carriages.

The multiple-stage heating to be carried out of the weld seam area following the laser welding head is largely dependent on the structure of the steel strip. The laser welding head is to this end by an optimal spacing from the laser welding head adapted to the process requirements and determined, e.g., by temperature measurement. According to the invention, however, independent movement of the line inductor controlled by the laser welding head is also possible, in order, for example, to avoid local overheating in the weld seam areas, to which end, for example, the spacing from the laser welding head is changed cyclically.

The multiple-stage heating of the advancing weld seam area, which is carried out by a line inductor part upstream of the laser welding head, can be carried out by the laser welding head at the speed thereof due to the directly following heating, which is why, for example, it is then possible and optionally also advantageous to solidly connect this line inductor to the laser welding head or to couple it directly to the laser welding head. However, it is also possible here, if required for process adjustment, to arrange the line inductor with periodically varying spacing change upstream of the laser welding head.

The advantages that can be achieved with the line inductors embodied in a multiple-stage manner are thus summarized as follows:
Distribution of the power density and thus control and reduction of the risk of overheating at the end of the heating zone,
A fixed structure without changeable conductor lengths,
The loop distribution in direct active proximity to the steel strip
A compact design.

Further details of the invention are explained in more detail below based on embodiments shown in diagrammatic figures. Therein:

FIG. 1 shows an apparatus for heat treatment of the weld seam,

FIG. 2 shows a single-stage line inductor according to the prior art,

FIG. 3 is a time-temperature diagram in the case of single-stage heating,

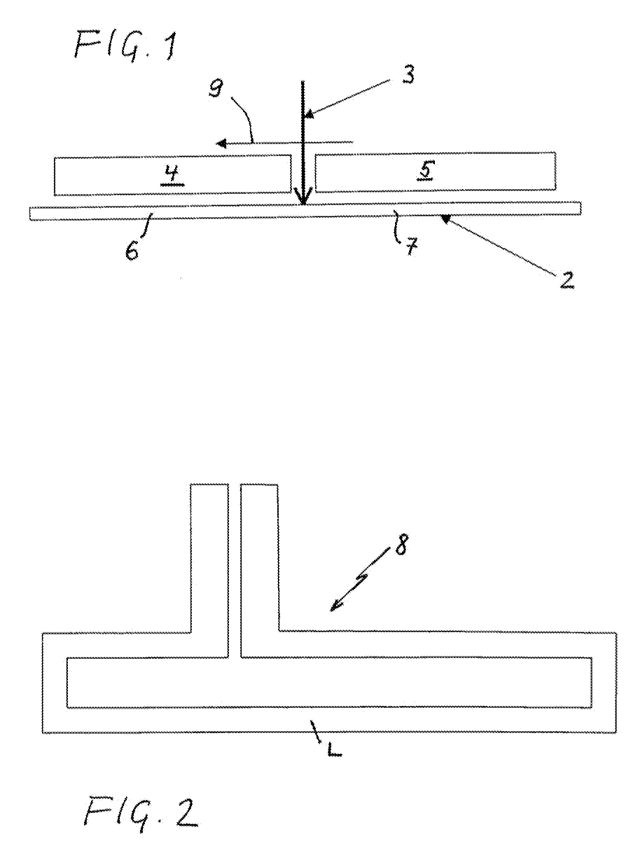

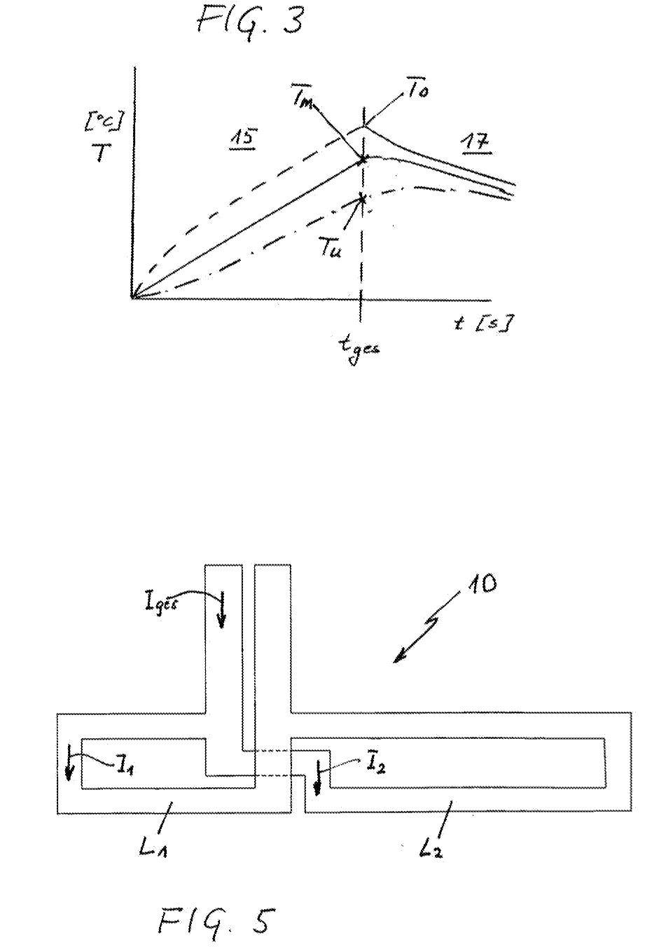

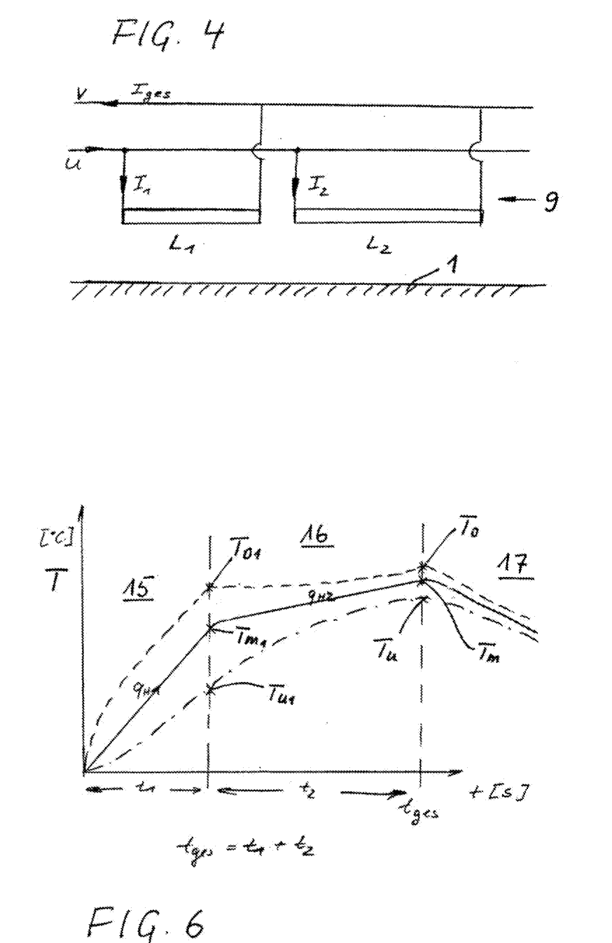

FIG. 4 shows the current distribution of a two-stage line inductor,

FIG. 5 shows a two-stage line inductor with the current distribution of FIG. 4,

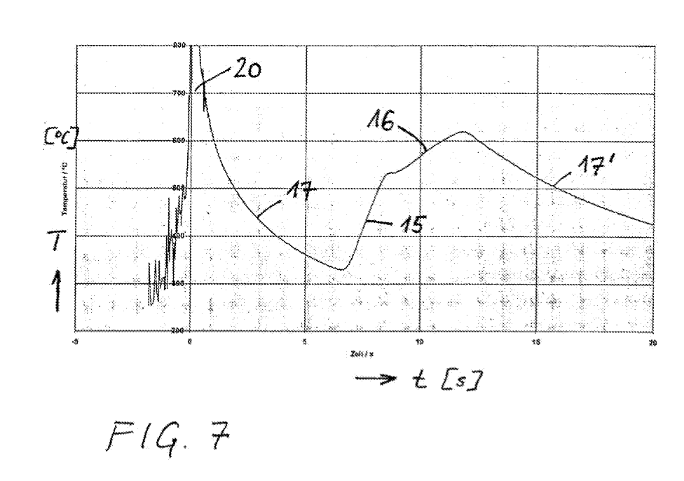

FIG. 6 is a time-temperature diagram in the case of two-stage heating,

FIG. 7 is a time-temperature diagram of a two-stage postheating with reheating.

FIG. 1 shows diagrammatically an apparatus for the welding and heat treatment of a weld seam 1 (see FIG. 4) in a steel strip 2. It comprises a laser welding head 3 and a line inductor 4 arranged upstream of it and a line inductor 5 arranged downstream of it. In this illustrated embodiment the laser welding head 3 and the two line inductors 4 and 5 are moved in the travel or welding direction 9 for the welding operation and for the heat treatment, while the steel strip 2 is stationary. The embodiment shown here can also be used for moving metal sheets with a fixed arrangement of the line inductors 4 and 5 and of the laser welding head 3. The line inductor 4 upstream of the laser welding head 3 heats the steel strip 2 upstream of the weld seam area 6 along the length of the line inductor 4 and in the same manner the weld seam area 7 following (trailing) the laser welding head 3 is postheated by the following line inductor 5 arranged downstream of the laser welding head 3.

The line inductors used for heat treatment are usually embodied in a single-stage manner according to the prior art. A single-stage heating process carried out with such a line inductor 8 shown by way of example in FIG. 2 with only one conductor loop with a single inductor L produces the schematic time temperature diagram shown in FIG. 3. As can be seen from the diagram, there is a greater temperature difference with a maximum at the end of the heating period t_{ges} between the temperature Tₒ of the upper surface of the strip and the temperature Tᵤ of the lower surface of the strip, since the temperature difference is directly proportional to the heating power density q of the line inductors and the heating time t. Deviations from the process temperature Tₘ aimed for at the end of the heating zone 15 and before the start of the cooling zone 17 is in part too great, which is why there is a risk of overheating of the structure.

FIG. 4 shows a two-stage line inductor with two inductor parts L₁ and L₂ of different lengths. Since the heating to the process temperature Tₘ aimed for with the two-stage line inductor (see FIG. 5) requires the same energy input Q·t_{ges}=qₕ₁·t₁+qₕ₂·t₂ as with the single-stage line inductor 8 (with qₕ₁·t1 for the first heating stage and qₕ₂·t₂ for the second heating stage) and the current distribution I_{ges} on the partial currents I₁ and I₂ is inversely proportional to the size of the two inductor parts L1 and L2, with corresponding selection of the size of the inductor parts, the energy input for individual heating stages can be controlled.

The current distribution to the inductor parts L₁ and L₂ of different lengths of the two-stage line inductor 10 resulting therefrom is shown in FIG. 5. The shorter stage L₁ with greater power density I₁ compared to the longer stage L₂ is located upstream in the welding direction 9, i.e. the weld seam area to be treated is first acted on with a higher power density. FIGS. 4 and 5 further show how the power distribution with a two-stage line inductor 10 can be realized through special arrangement and power supply of the two conductor loops with their inductor parts L₁ and L₂ of different lengths.

The result of two-stage heating carried out with a line inductor 10 of this type now produces the schematic time temperature diagram shown in FIG. 6. Although the steep temperature increase in the first heating stage 15 likewise leads to marked temperature differences between the strip temperatures Tₒ and Tᵤ at the end of the first heating stage at t₁, subsequently in the second heating stage 16 temperatures equalize over the time period t₂, so that after the end of this second heat treatment at t_{ges} temperature deviations from the average value aimed for of the strip temperature Tₘ with respect to the single-stage heating turn out to be much lower.

The real result of a two-stage postheating and reheating is shown in FIG. 7. The shape of the temperature curve begins in the time temperature diagram shown here with the direct welding area 20 at t=0 with subsequently rapid cooling 17. At a predetermined temperature, in this case approximately 320° C., the first heating stage 15 of the reheating begins with a steep increase in temperature with a duration of about 1.7 seconds up to a temperature of about 520° C. Immediately thereafter the second heating stage 16 follows with a now more gradual temperature increase up to a total warming time of about 3.3 seconds and a final temperature of about 620° C. Subsequently, a final cooling takes place with flat cooling curve 17′ due to the reheating. However, there are cases in which the zone 16 is a purely holding zone or even a zone with delayed cooling. With a delayed cooling the energy fed into the system is not sufficient to equalize the heat loss to the environment.

### LIST OF REFERENCE NUMBERS

1 Weld seam
2 Steel strip
3 Laser welding head
4 Line inductor for preheating
5 Line inductor for postheating
6 Advance weld seam area
7 Trailing weld seam area
8 Single-stage line inductor
9 Welding direction, direction of movement
10 Two-stage line inductor
15, 16 Heating up zone
17, 17′ Cooling zone
20 Direct welding area
L Inductor part
L₁, L₂ Inductor part of the line conductor
I₁, I₂ Current strength
T Strip temperature
Tₒ Temperature of upper surface of strip
Tᵤ Temperature of lower surface of strip
Tₘ Average strip temperature
t Time
t₁ End of the first heating stage
t₂ End of the second heating stage
T_{ges} Total heating time

1-15. (canceled)

16. A method for the inductive heat treatment of weld seams in a welding machine with a laser welding head for connecting steel strip,
a heating process of the weld seam and the adjacent weld seam areas upstream and downstream of the actual weld being carried out by line inductors,
the weld-seam area being heated by an adjustable multipart line inductor whose parts can define zones of different power densities, the inductor having a multiple division of its conductor loop lengths and/or with a different plating of the conductor loops and/or with a plurality of spacing steps from the steel strip,
wherein
division of the entire heating power density to be applied for the heating in first and second heating stages is carried out such that a steeper temperature increase takes place in the first heating stage than in the second heating stage.

17. The method according to claim 16 wherein the power distribution between the first heating stage and the second heating stage is carried out in a ratio of 3:1 in the case of a two-stage heating.

18. The method according to claim 16 wherein a dwell time with a temperature specially adjusted by temperature measurement, with subsequent cooling of the previously heated weld seam area is provided between individual heating stages, which is then followed by a re-heating

19. An apparatus for inductive heat treatment of weld seams in a welding machine with a laser welding head for connecting steel strips, the apparatus comprising:
an adjustable multipart line inductor that can be used for preheating and postheating with different power density over its length, the division of the power density being produced by
several conductor loops and stepwise change of the partial conductor lengths or
a different plating of the conductor loop over its length, wherein a different power density can also be achieved within one conductor loop or
different stepwise relative spacings between the line inductor and the steel strip, through which likewise a different power density is produced within a conductor loop.

20. The apparatus according to claim 19 wherein the individual conductor loops are separated to produce equalization zones between individual heating zones.

21. The apparatus according to claim 19 wherein the line inductors for the preheating and postheating are controllable individually or together.

22. The apparatus according to claim 19 wherein one line inductor is upstream of the laser welding head and one line inductor is downstream of the laser welding head with variable spacing.

23. The apparatus according to claim 19 wherein the line inductor is connected to the laser welding head.

24. The apparatus according to claim 19 wherein the steel plate is firmly clamped and the laser welding head and the line inductors are displaceable.

25. The apparatus according to claim 4 wherein the steel plate is displaceable and at least the laser welding head is arranged in a fixed manner.

26. (canceled)

27. A method of welding together edges of two metal strips, the method comprising the steps of:
relatively displacing a laser welding head and the metal strips in a predetermined direction such that the head passes the edges of the strips while welding the edges together with the head;
heating the edges upstream of the head with an upstream line inductor at a high power density so as to rapidly heat the edges upstream of the head; and
heating the edges downstream of the head with a downstream line inductor at a lower power density so as to heat the edges less rapidly than with the upstream line inductor.
